(19) United States
(12) Patent Application Publication
(10) Pub. No.: US 2024/0005348 A1
(43) Pub. Date: Jan. 4, 2024

(54) SYSTEMS AND METHODS OF PROPERTY VALUATION

(71) Applicants: Corentin Guillo, Toulouse (FR); Sivakumaran Somasundaram, Glasgow (GB); Pablo Lopez Santori, Glasgow (GB); Ali Salman, Glasgow (GB); Gordon Campbell Wells, Glasgow (GB); Avnish Kumar, Glasgow (GB)

(72) Inventors: Corentin Guillo, Toulouse (FR); Sivakumaran Somasundaram, Glasgow (GB); Pablo Lopez Santori, Glasgow (GB); Ali Salman, Glasgow (GB); Gordon Campbell Wells, Glasgow (GB); Avnish Kumar, Glasgow (GB)

(21) Appl. No.: 17/854,327

(22) Filed: Jun. 30, 2022

(51) Int. Cl. G06Q 30/02; G06Q 50/16

(52) U.S. Cl. CPC G06Q 30/0206; G06N 20/00; G06Q 50/16; G06Q 30/0201

(57) ABSTRACT

The disclosure features a method which includes inputting or receiving information on one or more features of a plurality of residential properties and prices of the residential properties including a marketed price, a listing price, and a closing price, providing the information to a Machine Learning Algorithm to determine the relationship between the one or more features and the prices of the residential properties to create a Machine Learned Model, inputting or receiving information on one or more features of a new residential property into the Machine Learned Model, and predicting a base price of the new residential property from the Machine Learned Model based on the one or more features of the new residential property. The disclosure also features one or more non-transitory, computer-readable storage media storing instructions capable of performing the method and a computer or computer system capable of performing the method.

### FIELD

The present disclosure is directed to the field of real estate valuation. More particularly, the disclosure relates to systems and methods for performing a valuation of a new property using Machine Learning Algorithms.

### BACKGROUND

One of the challenges in the residential construction industry is estimating the price at which a new property should be sold at. A number of factors apart from the location weigh in. This price determines profit margins, and in a way, the very survivability of the builder company.

Traditionally, this has been done by studying historic prices of new homes sold in the region and manually extrapolating the target price for the new house under construction. There are several disadvantages to this approach. For one, this can be done only by individuals who possess a high level of domain knowledge. Secondly, there is no explanation of how the price was arrived at.

Competitive Market Analysis (CMA) is a time-tested solution to establish a snapshot of the housing market supply and pricing in an area. The user (typically a builder or a residential property developer) has a plan to build certain type(s) of house(s) in a location. The proposed house(s) is, in the industry, called a “subject property”. The subject property has a set of certain identifying features that include a proposed minimum price, proposed maximum price, minimum house size, maximum house size, lot area size, and location (latitude and longitude). The price refers to a base price and disregards premiums for white goods (special features such as special flooring, bathroom fittings, etc.) The user now wants to know the following:
Is the price estimate right for this market?
What are the comparable (also commonly known as comps in the industry) properties that existed in the past in this market?
Where are they located?
How do they compare to the subject property?
Should the price be adjusted because the market is saturated? Or alternately, is the subject property a novel introduction to the market?

The traditional approach for conducting a CMA is to do the following. The past data of new homes in the market would be imported into a spreadsheet such as Microsoft Excel©. The data would include location, minimum price, maximum price, minimum house size, maximum house size, typical lot size, location, and year and month of availability in the market. Once the data is fed into the spreadsheet, the next step would be to apply thresholds by value to each of the features listed above. For example, one step would be to apply a threshold of 60% to the column of lot size. This would only display past properties that fit the 60% criteria of the lot size. Finally, when all filters are applied this way in Microsoft Excel©, only the projects that meet all these criteria will be displayed. This would constitute the CMA for the given Subject Property. The locations of the CMA plotted on a digital map, a graph of Cost v Square Footage for the CMA, and a list is used to create a paper report and handed over to the user.

### SUMMARY

In general, in a first aspect, the disclosure features a method. The method includes inputting or receiving information on one or more features of a plurality of residential properties and prices of the residential properties including a marketed price, a listing price, and a closing price, providing the information to a Machine Learning Algorithm to determine the relationship between the one or more features and the prices of the residential properties to create a Machine Learned Model, inputting or receiving information on one or more features of a new residential property into the Machine Learned Model, and predicting a base price of the new residential property from the Machine Learned Model based on the one or more features of the new residential property.

In general, in a second aspect, the disclosure features one or more non-transitory, computer-readable storage media. The one or more non-transitory, computer-readable storage media have instructions for execution by the one or more processors, the instructions programmed to cause the one or more processors to input or receive information on one or more features of a plurality of residential properties and prices of the residential properties including a marketed price, a listing price, and a closing price, provide the information to a Machine Learning Algorithm to determine the relationship between the one or more features and the price of the residential properties to create a Machine Learned Model, input or receive information on one or more features of a new residential property into the Machine Learned Model; and predict a base price of the new residential property from the Machine Learned Model based on the one or more features of the new residential property.

In general, in a third aspect, the disclosure features a computer or computer system. The computer or computer system includes one or more processors designed to execute instructions, and one or more non-transitory, computer-readable memories storing program instructions for execution by the one or more processors, the instructions programmed to cause the one or more processors to input or receive information on one or more features of a plurality of residential properties and prices of the residential properties including a marketed price, a listing price, and a closing price, provide the information to a Machine Learning Algorithm to determine the relationship between the one or more features and the price of the residential properties to create a Machine Learned Model, input or receive information on one or more features of a new residential property into the Machine Learned Model, and predict a base price of the new residential property from the Machine Learned Model based on the one or more features of the new residential property.

Features of the method, non-transitory, computer-readable storage media, and computer or computer system can include the following. The one or more features of the plurality of residential properties and/or of the new residential property are chosen from features including square footage, lot area, number of beds, number of baths, number of floors, garage size, lot width, home owner association fee, and geographic location. The Machine Learning Algorithm can be a decision tree-based algorithm such as Random Forest or Gradient Boost. The geographic locations of similar residential properties used to predict the base price of the new residential property can be plotted on a map. Each contribution of the one or more features of the new residential property on the base price prediction can be determined. The contribution of each feature can be plotted as a SHAP Value ($) or as a Features Force Plot. The geographic location of the new residential property can be determined by way of a mapping application. The inputting or receiving steps can be performed on a graphical user interface. The providing and predicting steps can be performed by one or more computer processor.

It should be understood that the method, non-transitory, computer-readable storage media, and computer or computer system are not to be considered limitations on the invention defined by the claims. The featured method, non-transitory, computer-readable storage media, and computer or computer system can be implemented in one or more ways using one or more features depicted in the drawings, described in the detailed description, and set forth in the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings illustrate certain aspects and principles of the implementations set forth, and should not be construed as limiting.

FIGS. 1A-1B are screenshots of a graphical user interface of a Google Maps application that allows a user to determine a location in latitude and longitude where a subject project or subject property will be built.

FIGS. 2A-2B are screenshots of a graphical user interface of an alternative application (Bird.i) that allows a user to determine a location in latitude and longitude where a subject project or subject property will be built.

FIG. 3A is a screenshot of a graphical user interface which allows a user to enter information related to a subject project and execute a Competitive Market Analysis (CMA) according to one implementation.

FIG. 3B is a table showing the use of weighting factors to be inputted for the CMA of FIG. 3A according to one implementation.

FIG. 4 is a screenshot of a graphical user interface showing a CMA output in tabular form according to one implementation.

FIGS. 5A and 5B are screenshots of a graphical user interface showing the CMA output of FIG. 4 in graphical and map form according to one implementation.

FIG. 6 is a screenshot of a graphical user interface for inputting information for predicting the base price of a subject property according to one implementation.

FIGS. 7A and 7B are screenshots of a graphical user interface displaying the output of the predicted base price and range for the subject property as well as a map view of similar properties, with FIG. 7B showing a pop-up display of information for a selected property.

FIG. 8 is a screenshot of a graphical user interface displaying a Features Importance Plot and a Features Force Plot showing the relative contribution or measure of impact of each of the features in determining the predicted base price and range for the subject property.

FIG. 9 is a schematic diagram depicting a method according to one implementation.

FIG. 10 is a schematic diagram depicting a computer or computer system according to one implementation.

### DETAILED DESCRIPTION

Reference will now be made in detail to various illustrative implementations. It is to be understood that the following discussion of the implementations is not intended to be limiting.

As used herein, a “property” is a single house, apartment, townhouse, condominium, villa, or other residential unit, while “project”, “housing project”, “residential housing project”, “construction project”, or “residential construction project” refer to a set of related properties constructed by a single builder. A “subject” property or project is a new property or project that is proposed to be built.

The disclosure provides a method of determining a set of the most similar past projects to a new real estate project based on their features at their time of completion. The method includes importing data on the past projects into an algorithm and using that information to rank the projects most similar to a new real estate project based on a measure of distance to create a CMA Set. The method also includes establishing the price of a new property. The property can be a house, apartment, townhouse, condominium, or villa. The method includes importing data related to the new property into a Machine Learned Model to predict what the base price of the new property should be as well as output each factor's contribution in the prediction. The prediction of the price can be based on regression models such as linear or multivariate regression. In such a model, the linear effect of various features associated with the property is measured and then applied to an input set of features. For example, if the data contained price information for houses along with features such as square footage, number of bedrooms, number of baths, garages, floors and garden size, the model would then arrive at coefficients for each of these features (the process which we call learning) and then apply them to a new, unseen input to predict price. In other implementations, a decision-tree based model such as a Random Forest model is used to predict the base price of the new property.

The method includes creation of a set of housing projects (called Set, or in short, CMA Set) that are similar to an inputted subject housing project (i.e., new project). The set of housing projects includes pricing information. The inputted subject housing project can include multiple units including houses, apartments, townhouses, condominiums, or villas. Statistical modelling is used to predict a value for the base price of a new property (individual house, apartment, townhouse, condominium, or villa) by comparing features of the new property to features of a set of housing projects used to train a Machine Learned Model to determine the relationship between the features and price information (e.g., marketed, listed, closing) and using the features to predict the base price. The statistical modelling can be based on a Machine Learning Algorithm that can be used for tabular style datasets such as decision trees and their offshoots (e.g., Random Forest, Gradient Boost) as well as regression models such as linear or multivariate regression. The Machine Learned Models can output the importance or relative contribution of each factor used to create the prediction.

Thus, for a given input project data on a subject housing project, an automatic method of creating a CMA set using similarity measure algorithms is established. For a given input data on a subject property, the base price is predicted based on a comparison of features with those trained to create a Machine Learned Model. With the added use of explanatory modules, it is possible to exactly determine the contribution of each housing feature to the predicted base price. Therefore, with the simple act of inputting the details for a new property, a price recommendation and contributions of various features are outputted.

One implementation of the disclosure provides a computer-based method of recommending the price that a new property should be sold at. The method can include one or more of receiving tabular data containing details of property prices for past projects along with the price they were sold at, tuning a Machine Learning Algorithm such as a decision tree-based algorithm such that an approximate function is identified to establish the relation between the input data and the corresponding price to create a Machine Learned Model, and building an explainer algorithm such that it establishes the contribution of each variable to the prediction made by the model. The method can further include one or more of receiving data about a new residential project in a geographic area of interest, selecting the most similar projects from the past that were constructed in the geographic area of interest to create a Competitive Market Analysis set, training a Machine Learning Algorithm such as a decision tree-based algorithm with the data from the selection above, determining the recommendation of a price for the new residential project, determining the contribution of each of the features of the new residential housing project to the price, and creating a schema of all information related to a property, distinguished by a globally unique identifier. The steps of the method can be performed by one or more graphical user interface in conjunction with computer program instructions executed by one or more processors.

The following figures depict different implementations of a graphical user interface of an application and/or website capable of performing method implementations described herein. The graphical user interface will be described with respect to specific icons, fields, buttons, and other features which are displayed on a screen or display of a computer or computing device and are selectable by a user of the application and/or website by way of a mouse, touchscreen, or other input device such as a pen or stylus and provide for input. Selection of the icons and other features by a user activates certain method steps for performing various functions executable as computer program instructions on a stationary computer or portable computer/computing device. These computer program instructions may be provided to one or more processor(s) of a general-purpose computer, special purpose computer, or other programmable data processing device or combination of devices, such that the instructions, which execute via the processor or processors of the computer or other programmable data processing device(s), create means for implementing the method steps. As such, methods described herein can be performed as a series of steps which are implemented as computer-readable code, computer-readable instructions, computer-executable instructions, or “software” performed by one or more processor(s). Such software can be loaded onto a memory or memories of a computer, portable computer/computing device, or system or combination thereof, as an application or program (or multiple applications and/or programs) capable of performing one or more steps of the method implementations. As can be appreciated, different steps or groups of steps of the method implementations can be performed by different computers or computing devices, or some or all can be performed by a single computer or computing device.

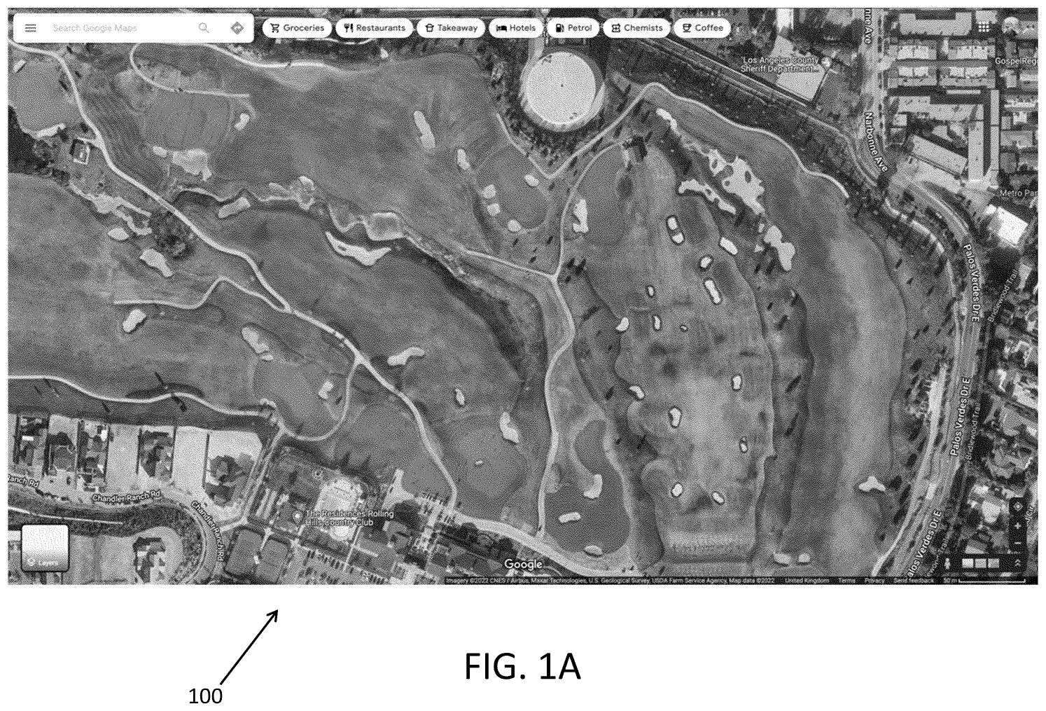

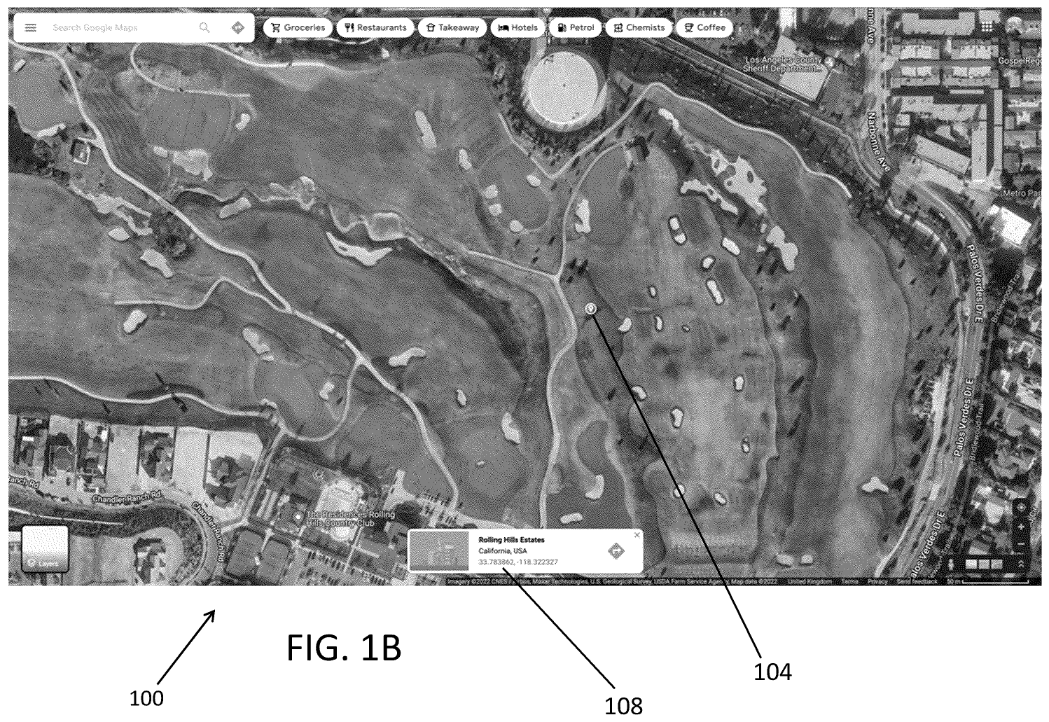

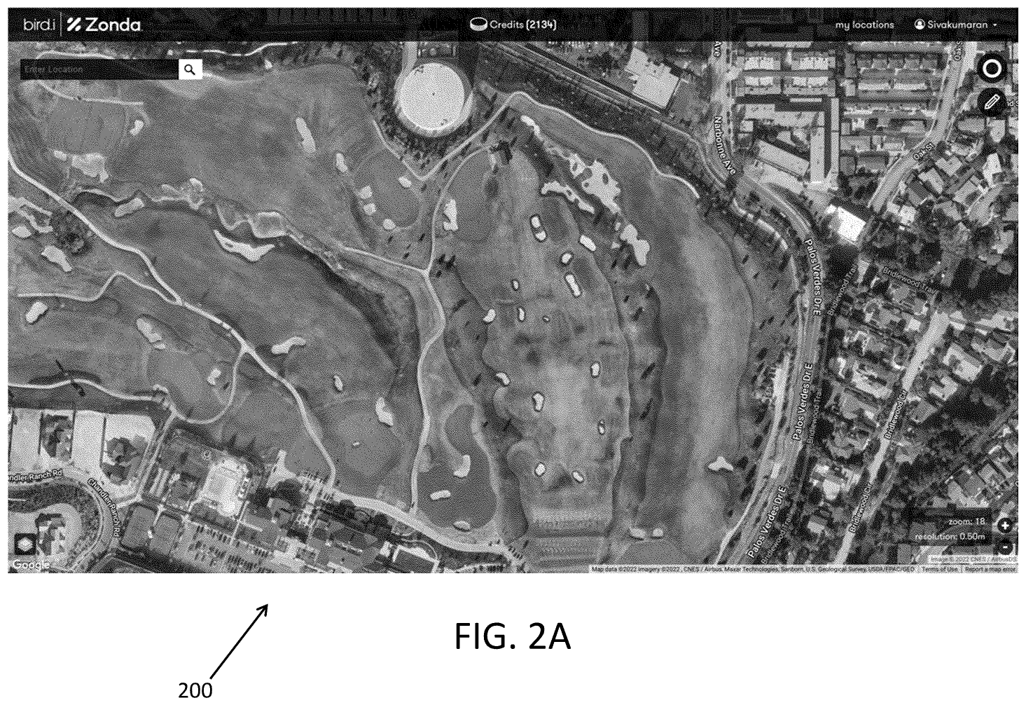

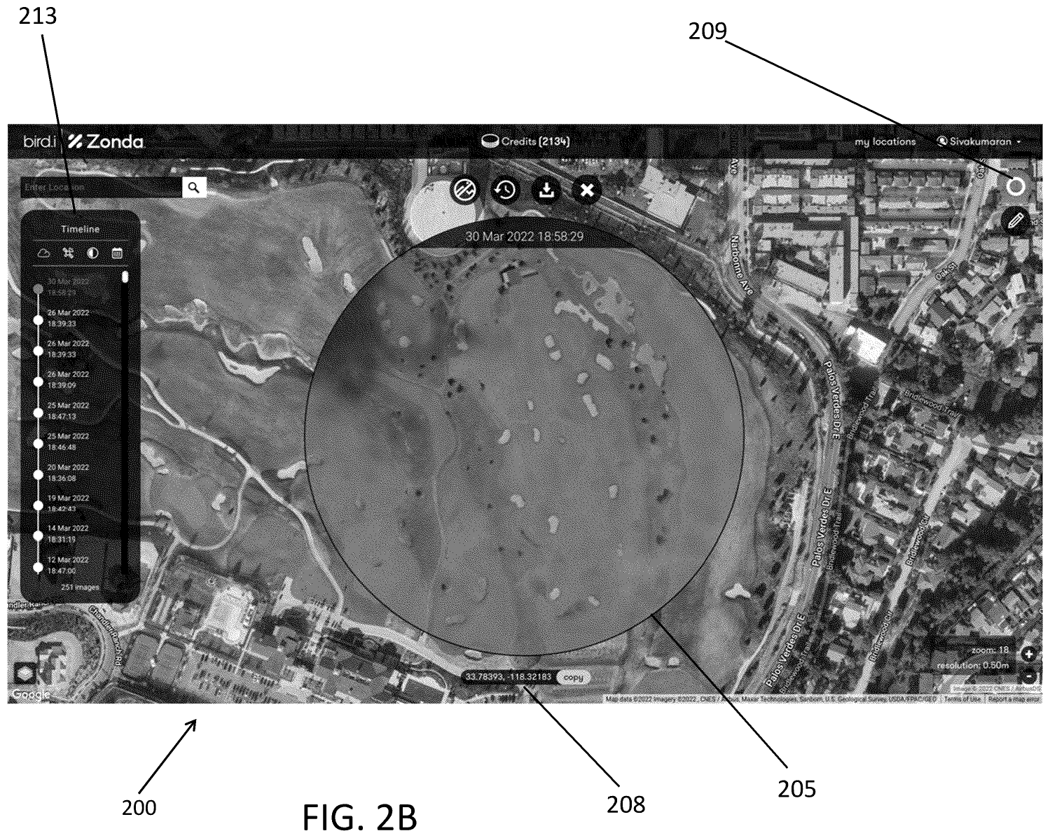

FIGS. 1A-2B provide graphical user interfaces which demonstrate how a user can obtain a location of a subject property or subject housing project. FIG. 1A shows a graphical user interface 100 of a Google Maps application where a user zooms into an area where the property or project is proposed to be built. The user then drops a marker 104 at the desired location, and Google Maps displays the geographic location 108 (i.e., latitude and longitude) of the location as shown in FIG. 1B. FIGS. 2A and 2B show a graphical user interface 200 of an alternative application (Bird.i) which provides similar functionality, with FIG. 2A showing the user zooming into the area where the project or property is proposed to be built, and FIG. 2B showing enablement of an image viewer 205 by selection of an Enable Viewer icon 209, where the latitude and longitude of the location 208 are shown. Other third-party mapping services providing latitude and longitude, such as Bing Maps, can be used as well. At the left of a screen is a timeline 211 which allows the user to select satellite or aerial images taken at different dates and times. The locations 108 and 208 can be subsequently used as input into an application capable of predicting and/or estimating the price of a new residential property.

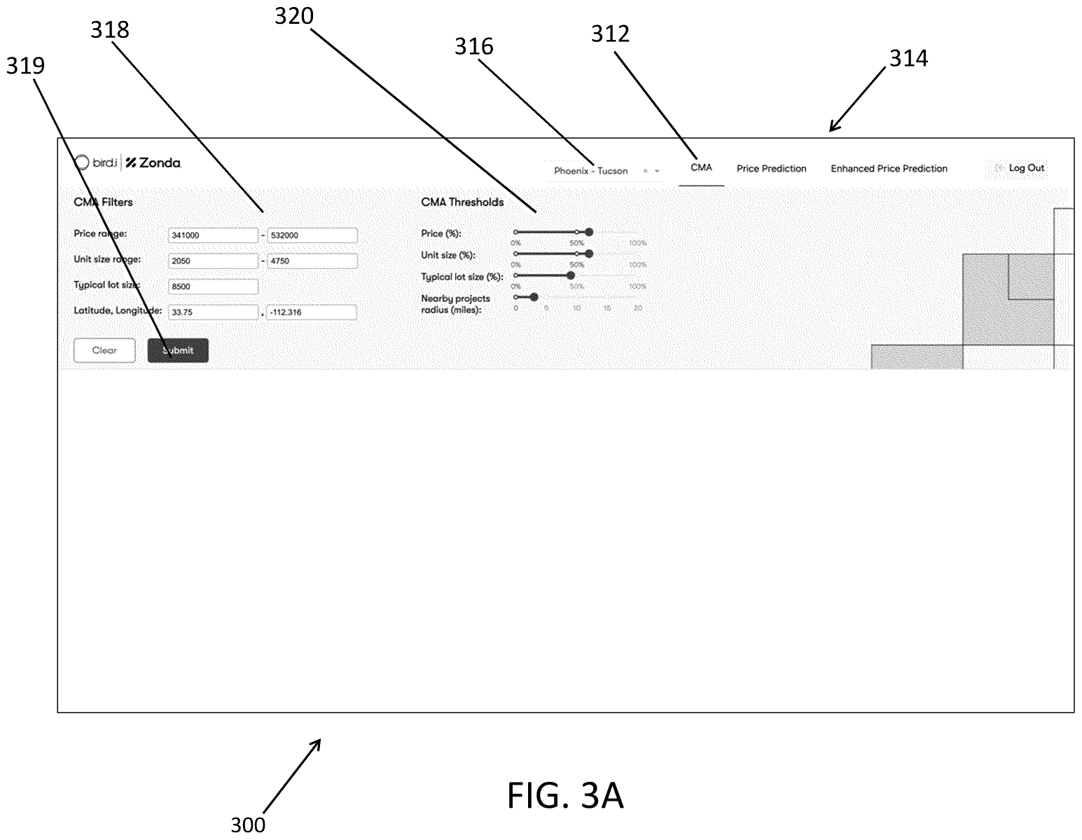

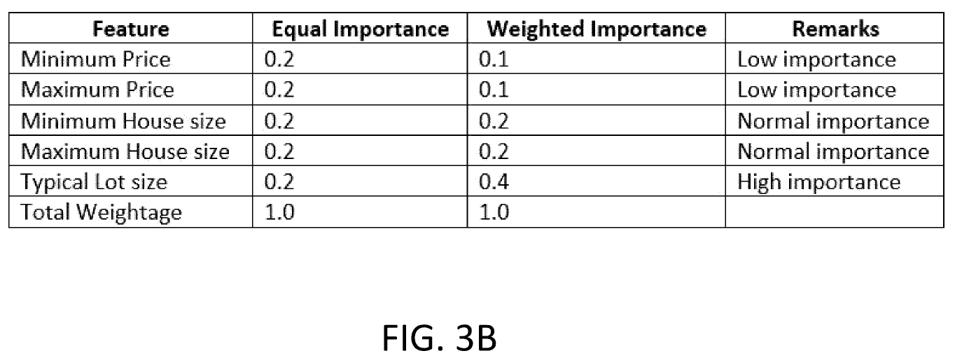

FIG. 3A provides a graphical user interface 300 which allows a user to execute a CMA. The user selects CMA 312 from an application menu 314 at the top of the screen. A general location 316 is chosen from a drop-down menu next to the application menu, or inputted manually, as a metropolitan region. At the top left of the screen, input fields are provided for a user to enter CMA Filters 318 for a subject project such as a price range, which can be a range that a builder intends to sell, unit size range, typical lot size, and the location of the subject project as geographic coordinates (i.e., latitude and longitude). In other implementations, other location information, such as city, county, state, zip code, zip+4 code, and tax parcel number can be inputted. At the top center of the graphical user interface 300 displayed on the screen, the user can toggle CMA thresholds 320 for price, unit size, and typical lot size, as 0 to 100% of the inputted values, while a radius of nearby projects from the inputted geographic location can be toggled as a distance from the inputted geographic area in miles. The CMA Thresholds adjust each inputted value according to a percentage, such that 0% would require an exact match to the inputted value (e.g., lot size 8500) and 100% would permit a range from minus 100% of the value to plus 100% of the value (e.g., lot size 0 to 17000), while 50% would permit a range from minus 50% of the value to plus 50% of the value (e.g., lot size 4250 to 12750). The inputted price in this case can be what the construction project would be marketed at for new available properties. Alternatively, or in addition, the price can be a sold price or a listing price. A submit button 319 allows the user to submit the CMA Filter 318 and CMA threshold 320 information to the application. FIG. 3B shows an alternative approach which allows weighting factors to be inputted for the CMA Filter information. For example, as shown in the table of FIG. 3B, the price range is provided with a weight of low importance (0.1), while the lot size is provided with a weight of high importance (0.4). House size is provided with a weight of normal importance (0.2). The weighting allows the user to select a degree to which some factors influence the CMA filtering more than others, or can provide all factors equal weight.

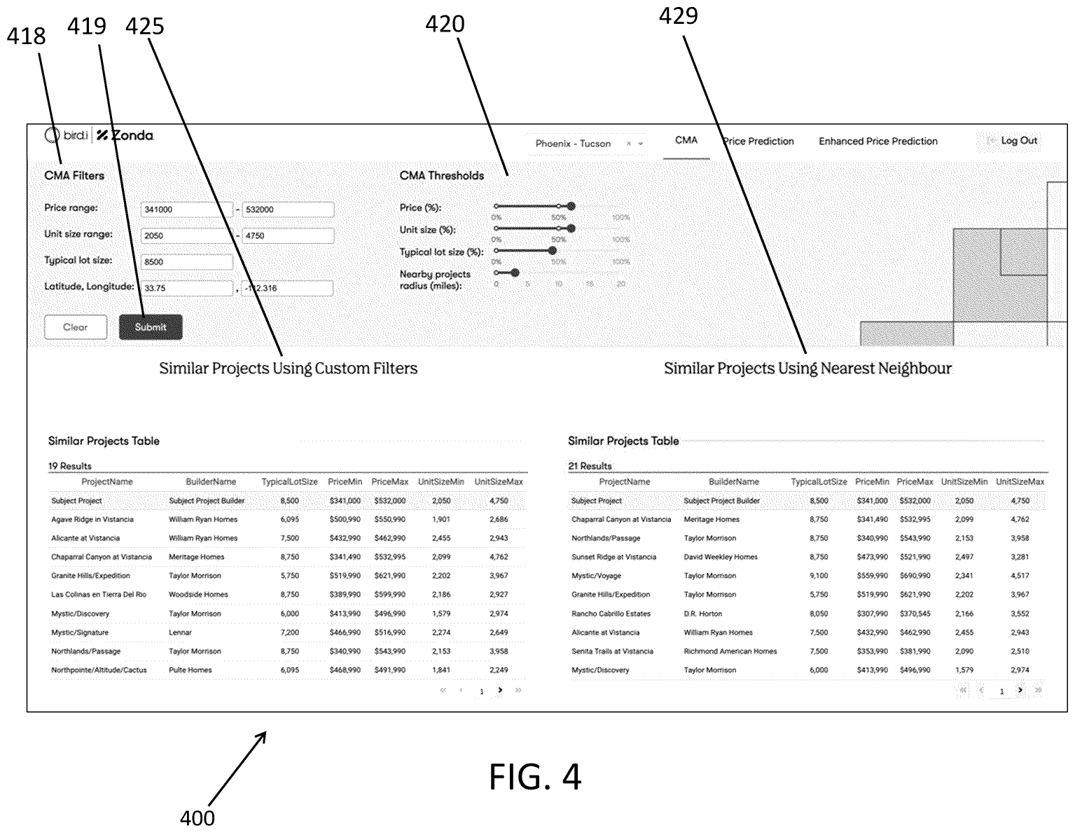

FIG. 4 shows a CMA output 400 in tabular form after the inputted CMA Filters 418 and CMA Thresholds 420 are submitted 419. Below the inputted information at the left shows a list of similar construction projects according to the filtering algorithm 425, which is based on the data inputted in the CMA Filters 418 and CMA thresholds 420. A list of similar construction projects according to the K-Nearest Neighbor (KNN) algorithm 429 is shown at the right, which identifies similar projects based on the inputted data 418 and does not rely on the CMA thresholds 420. The lists 425, 429 of similar construction projects provide CMA sets that are ranked by closest match and include information such as project name, builder name, typical lot size, minimum price, maximum price, minimum unit size, and maximum unit size. Information for the subject construction project is shown at the top of each list. As shown in FIG. 4, the results vary between each list 425 and 429 in terms of similar construction projects and where they rank in each list. In some implementations, weighting factors which assign features different levels of importance, such as shown in FIG. 3B, are used to rank the results in each list 425 and 429.

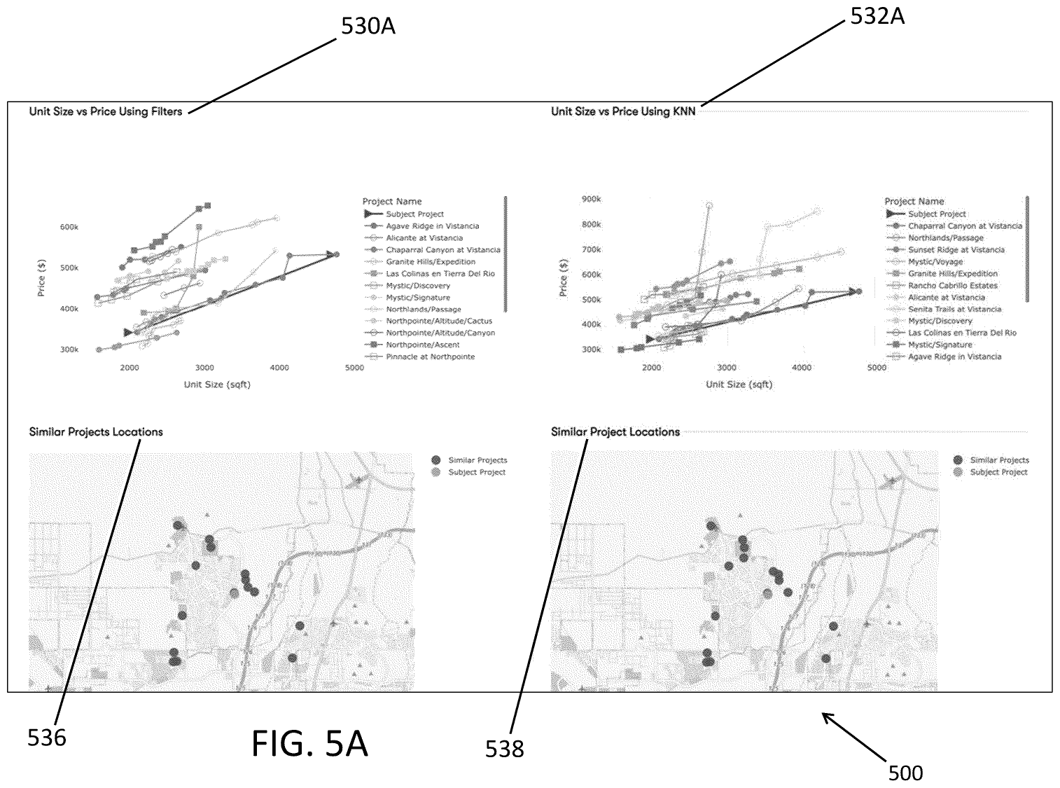

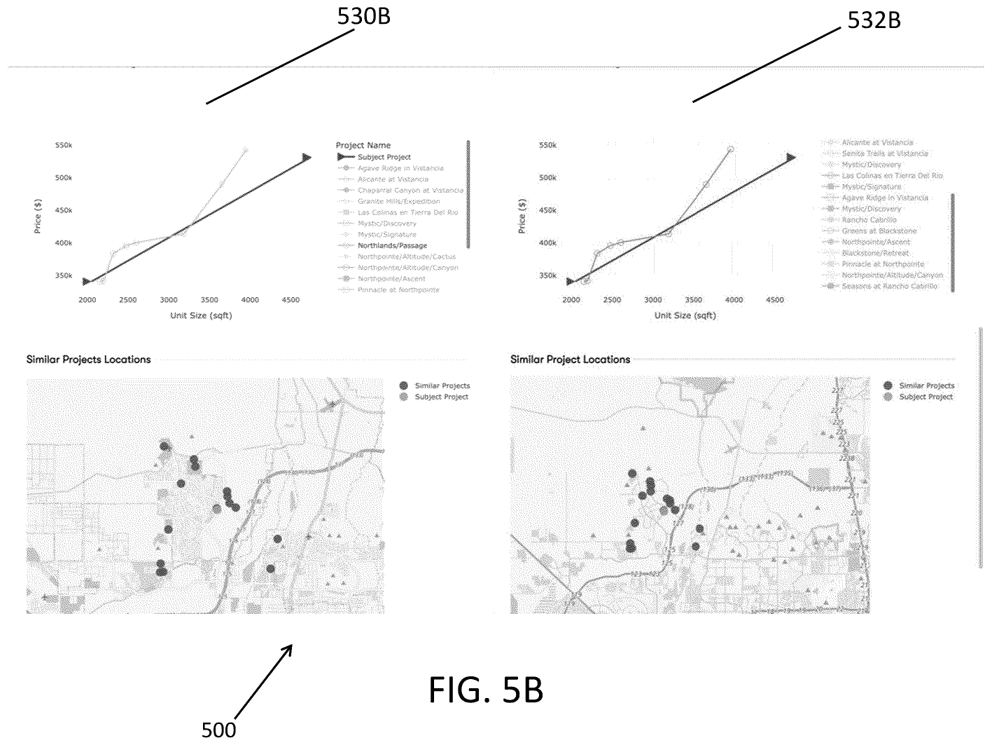

FIGS. 5A and 5B show a graphical user interface 500 showing the CMA output in graphical and map form. Each of the lines of the graph represent a different past construction project that match in similarity to the subject project. At the top left is a graph of price vs. unit size for similar projects using the filtering algorithm 530A while the top right shows the same graph for similar projects using the KNN algorithm 532A. The graphs show the price vs. unit size plots 530A and 532A for each of the results shown in FIG. 4. Each point on the graph represents an individual housing unit (e.g., house, apartment, townhouse, condominium, or villa) for the residential project. Maps displaying the locations of the subject project and similar projects for the filtering algorithm 536 and KNN algorithm 538 are shown below the graphs. The subject project is shown by an orange marker and similar construction projects are shown with purple markers. Scrolling over each project can display data such as price range (e.g., marketed, listing, and/or closing) as well as a location associated with each project. FIG. 5B shows the price vs. unit size plots for the filtering algorithm 530B and KNN algorithm 532B that have only one similar project shown in comparison to the plots for the subject project. Alternatively, or in addition, other graphs such as price vs. lot size can be included.

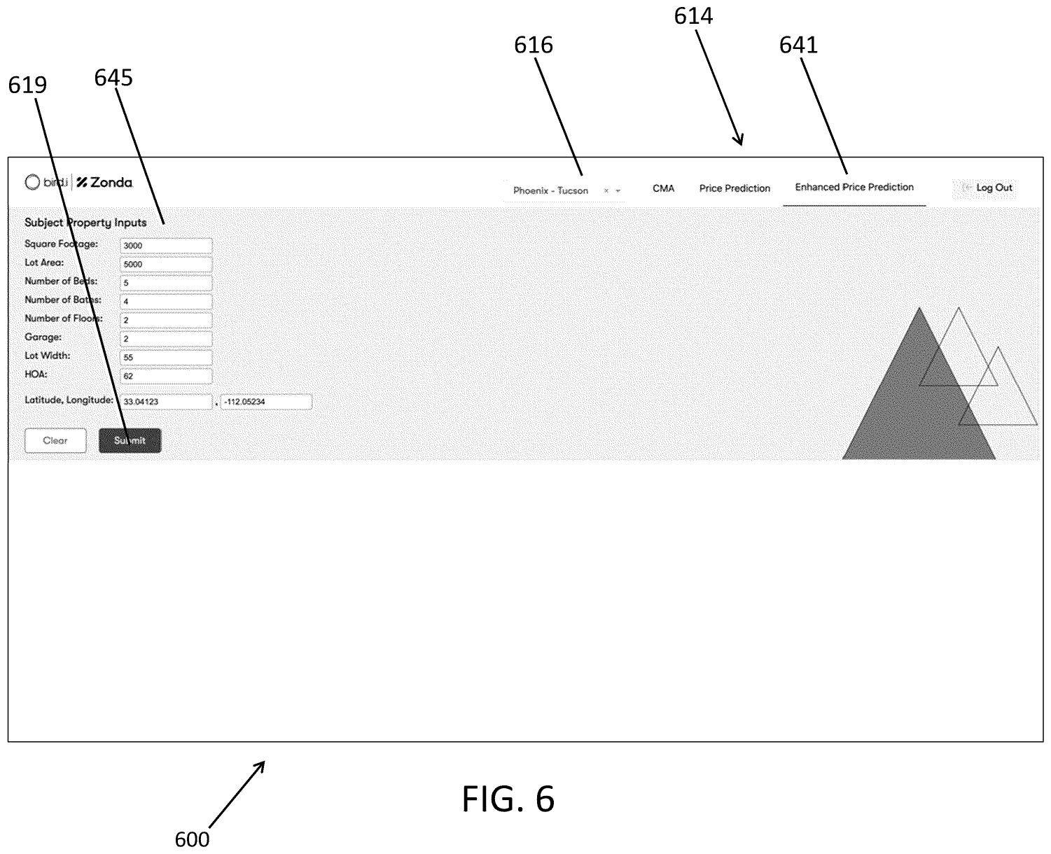

FIG. 6 shows a graphical user interface 600 for inputting information for predicting the base price of a new property. In the application menu 614 at the top of the screen, the user has chosen enhanced price prediction 641. To the left of the application menu 614, a general location 616 is chosen from a drop-down menu or inputted manually as a metropolitan area. At the top left are input fields 645 for the subject property, including square footage, lot area, number of beds, number of baths, number of floors, size of garage, lot width, and homeowners' association (HOA) fee. The geographic location of the subject property is inputted at the bottom of the input fields 645. A submit button 619 allows the user to submit the inputted information to the application for prediction of the price of the subject property based on a trained Machine Learned Model. The trained Machine Learned Model was created by providing information on a large dataset of property information including property features (e.g., square footage, lot area, number of beds, number of baths, number of floors, size of garage, lot width, and homeowners' association (HOA) fee) and property prices including a marketed price, listing price, and closing price to a Machine Learning Algorithm to determine the relationship between the one or more features and the prices of the residential properties. The Machine Learning Algorithm can be one used for tabular style datasets such as decision trees and their offshoots (e.g., Random Forest, Gradient Boost) as well as regression models such as linear or multivariate regression.

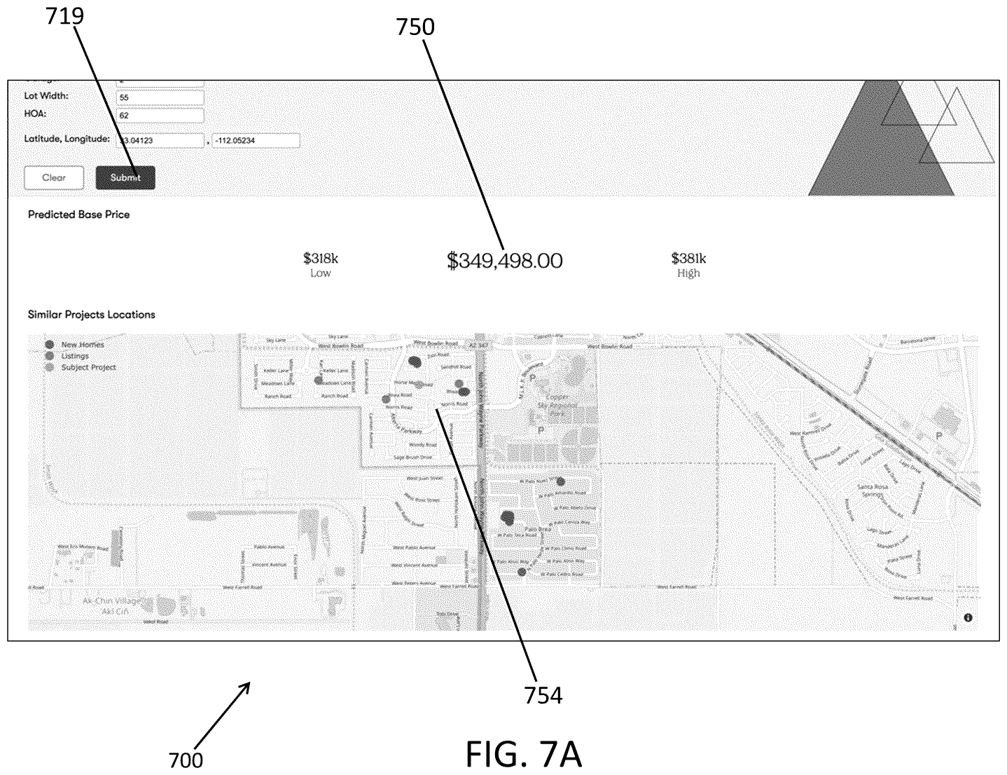

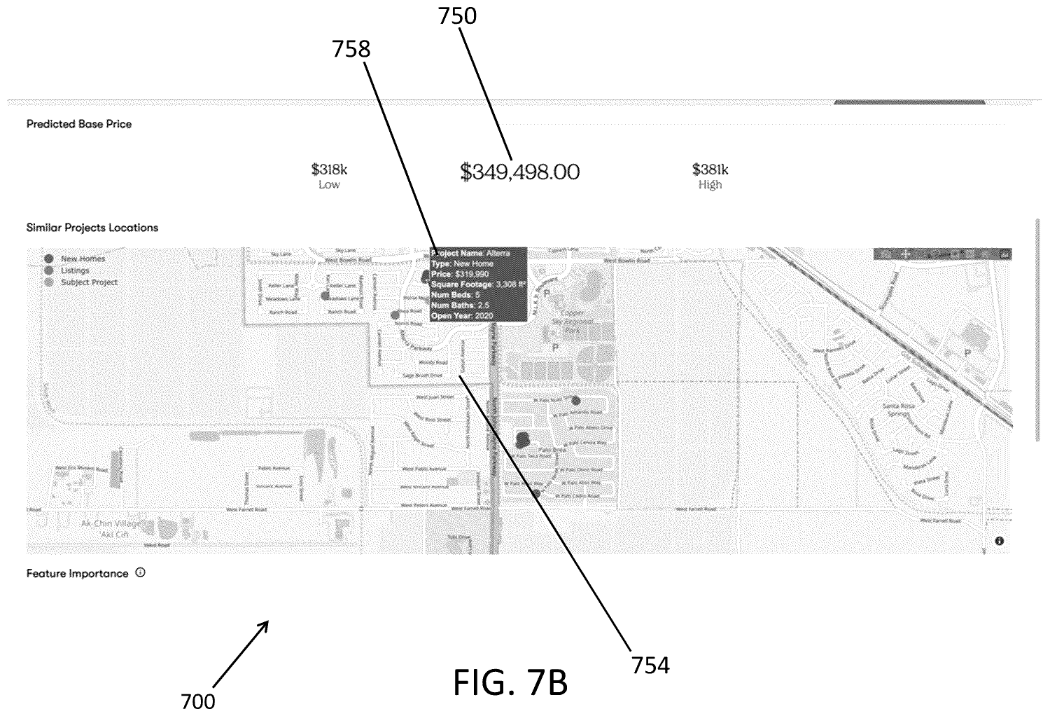

FIGS. 7A and 7B show a graphical user interface output 700 after the inputted information 645 from FIG. 6 has been submitted 719. The predicted base price and range (lower/upper bounds) for what the subject property should sell at are called out at 750, and below that is shown a map 754 displaying the subject property and similar properties. FIG. 7B shows a pop-up display 758 that shows information for a selected property upon right-clicking the icon of the property with a mouse. The pop-up display 758 includes information such as project name, property type, price, square footage, number of beds, number of baths, and open year.

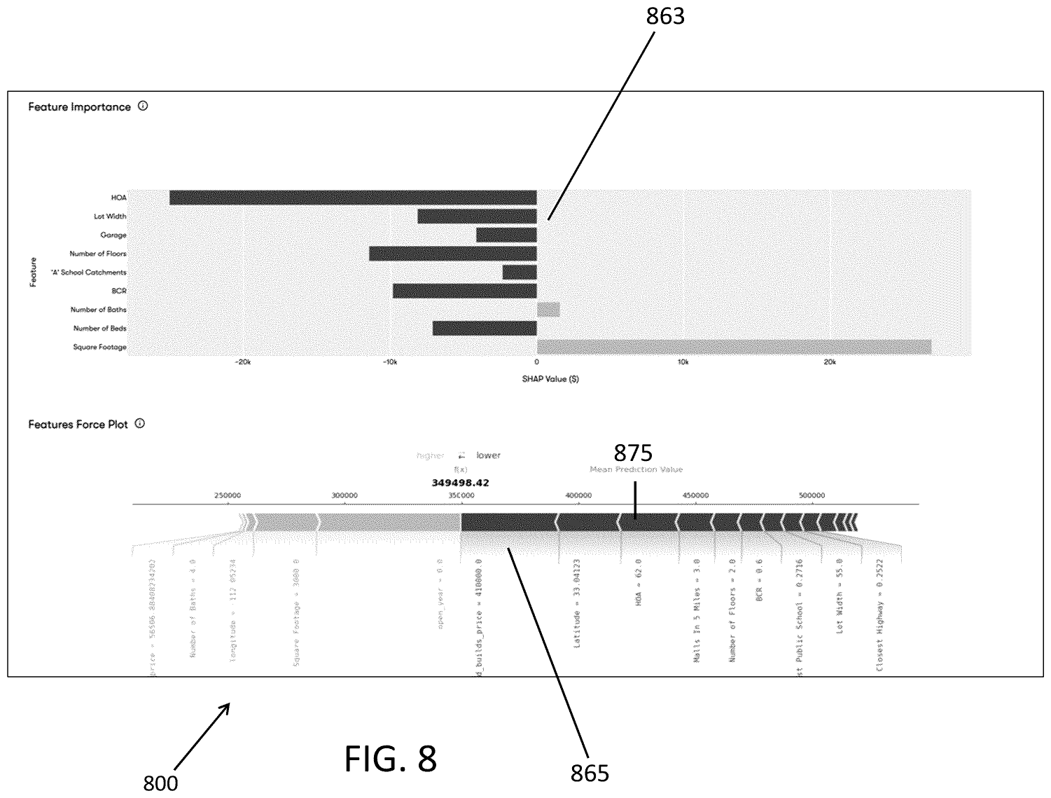

FIG. 8 shows a graphical user interface output 800 showing a Features Importance Plot 863 of the relative contribution or measure of impact of each of the features in determining the predicted base price and range of the subject property, as compared to the average home price in the market, as well as a Features Force Plot 865 displaying the same information in a different format. The Features Importance Plot 863 shows positive factors plotted at the right of the plot and negative factors plotted to the left. The plot 863 shows that HOA fee was the largest negative contributor to the price, while square footage was the largest positive contributor. Higher HOA fees generally correlate with higher home prices, so in this case the $62 HOA fee is lower than the average HOA in the area and caused the price to go down. The square footage of 3000 is better than houses in the area and caused the price to go up. The number of baths is about average for homes in the area and didn't have much of an impact on the price. The SHAP value ($) is the average price of a house in the area ($425K); having more negative factors than positive factors as shown lowers the price of the subject property to $349,498. The Features Force Plot 865 shows the factors plotted longitudinally according to mean prediction value, with the price of the subject property ($349,498) shown in bold. The average price in the area ($425K) is shown by line called out at 875. Factors plotted on the left (in green) cause the price of the subject property to go up, while factors plotted on the right (in blue) cause the price of the subject property to go down. As can be seen in both the Features Importance 863 and Features Force Plot 865, there were more negative factors dragging the subject property's price down than positive factors boosting the price, so the predicted price of the subject property ($349,498) was lower than the average price of $425,000 in the area.

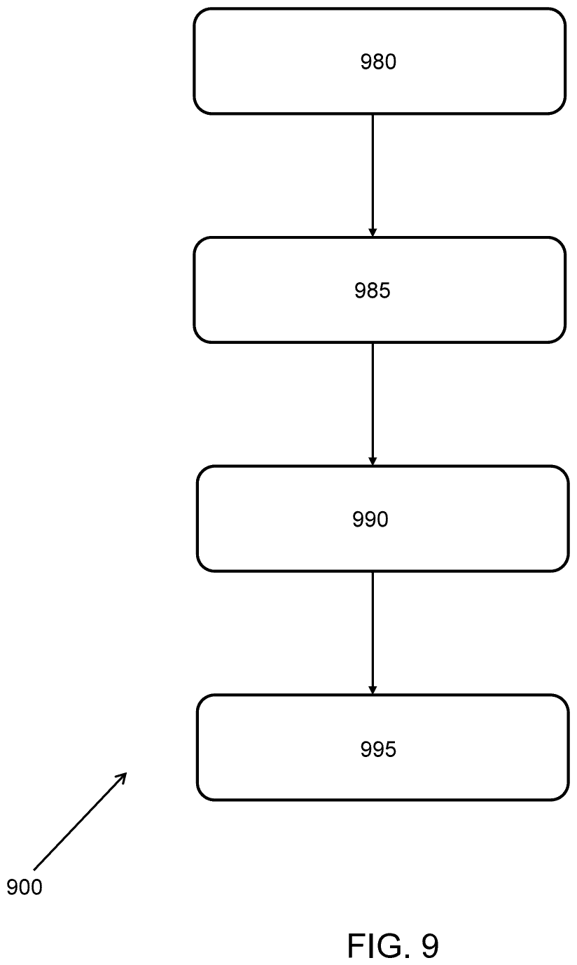

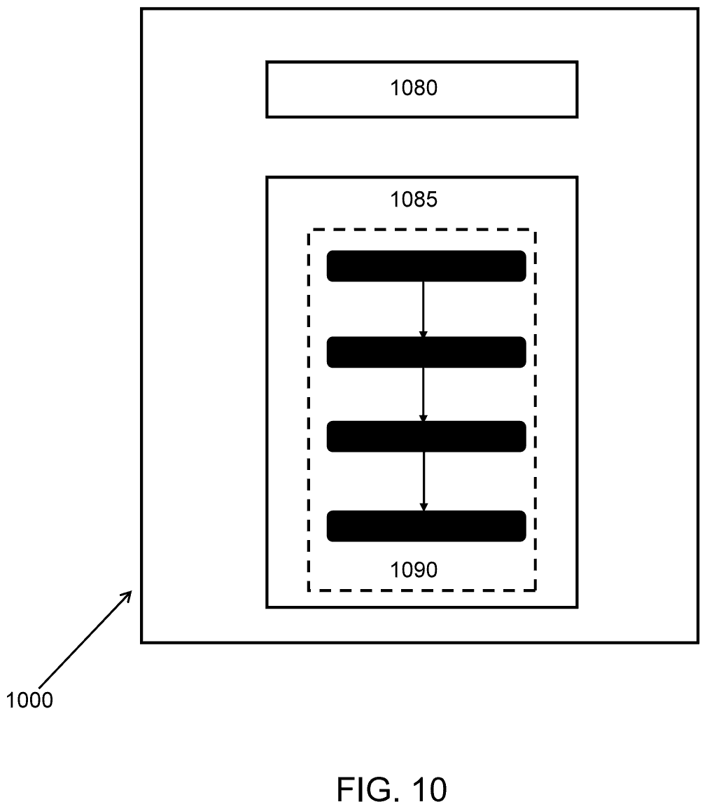

FIG. 9 depicts a method 900 that can be implemented by way of an application and/or dedicated website displaying one or more of the graphical user interfaces(s) depicted in FIGS. 1A-3A and FIGS. 4-8. Interaction of a user with the one or more graphical user interface(s) can provide input of information and cause instructions performable by one or more processor(s) to execute one or more step(s) of the method 900. The instructions can be stored on a non-transitory computer readable storage medium or media on a computer or computer system that also has one or more processor(s) designed to execute instructions. In one implementation, the method 900 includes inputting or receiving information on one or more features of a plurality of residential properties and prices of the residential properties including a marketed price, a listing price, and closing price 980, providing the information to a Machine Learning Algorithm to determine the relationship between the one or more features and the prices of the residential properties to create a Machine Learned Model 985, inputting or receiving information on one or more features of a new residential property into the Machine Learned Model 990, and predicting the base price of the new residential property from the Machine Learned Model based on the one or more features of the new residential property 995. FIG. 10 depicts a computer or computer system 1000 having one or more processor(s) 1080 designed to execute instructions, and one or more non-transitory, computer-readable memories 1085 storing program instructions 1090 for execution by the one or more processor(s) 1080, the instructions programmed to cause the one or more processor(s) to perform the method depicted in FIG. 9.

As can be appreciated by those in the computer engineering arts, inputting steps depicted in the figures, such as inputting a geographic area or other data related to a new housing project or property can be performed through one or more input-output (I/O) interface on a fixed position computer or computers such as a desktop computer or server or on a portable computer/computing device or devices, such as a tablet, laptop, PDA, gaming device, or smartphone. Visual prompting can take the form of a message and/or input field provided to the user on a display. The input field can be provided as part of a graphical user interface provided on the display of a computer(s) or computing device(s) which provides one or more data entry fields, check boxes, buttons, or pull-downs which allow the user to input a geographic area and associated data, as depicted in the figures or as implemented in other variations and designs known in the computer engineering arts. Auditory prompting can take the form of speech or a recording broadcast from a speaker which prompts the user to enter the geographic area or other data. Inputting steps can be performed through traditional inputting means such as a physical keyboard or a keyboard projected on a display, such as a touchscreen. The keyboard can be a QWERTY keyboard or a condensed keyboard commonly used in electronic devices such as cell phones. Inputting can also be performed through the user providing speech which is inputted through a microphone of the computer(s) or computing device(s) and recognized by speech recognition algorithms programmed on the computer or computing device. Outputting steps can be formed through a visual output device such as a display on the computer(s) or computing device(s).

Computer-executable code or instructions for performing method steps described or depicted herein can be implemented as software or an application capable of being run on the computer(s) or computing device(s). The computer-executable code or instructions can be installed on the computer(s) or computing device(s) during manufacture as software, or implemented as firmware or hardware (e.g., circuitry), or some combination of these. The computer-executable code or instructions can be configured to be downloadable onto the memory of the computer(s) or computing device(s) from a cloud storage source available on the Internet, such as an application retail source (e.g., “app store”) capable of being accessed from a mobile phone, tablet, laptop, gaming device, desktop computer, or other programmable device having components or features capable of performing the method steps described above. Examples of suitable internet-accessible sources include the Apple Store, Google Play, and other sites that make software applications and other downloads available for purchase or license. The computer-executable code or instructions can also be hosted on a server or servers accessible to users through a network connection, or can be distributed between a server and an application installed on a user's computer(s) or device(s).

The computer-readable code, computer-readable instructions, computer-executable instructions, or “software” can be organized into routines, subroutines, procedures, objects, methods, functions, or any other organization of computer-executable instructions that is known or becomes known to a skilled artisan in light of this disclosure, and can be programmed in any suitable programming language, including PHP, HTML, XML, XHTML, JavaScript, C, C#, C++, Java, Python, Perl, Ruby, Swift, Visual Basic, and Objective C. By such programming, the computer-readable code, computer-readable instructions, computer-executable instructions, or “software” instruct one or more processors of the computer(s) or computing device(s) to carry out the operations and commands of the application. Inputted locations or geographic areas can be stored in the computer(s) or computing device(s)'s memory. The memory can be implemented through non-transitory computer-readable storage media such as RAM. As used in the context of this specification, a “non-transitory computer-readable storage medium (or media)” may include any kind of computer memory, including magnetic storage media, optical storage media, nonvolatile memory storage media, and volatile memory. Non-limiting examples of non-transitory computer-readable storage media include floppy disks, magnetic tape, conventional hard disks, CD-ROM, DVD-ROM, BLU-RAY, Flash ROM, memory cards, optical drives, solid state drives, flash drives, erasable programmable read only memory (EPROM), electrically erasable programmable read-only memory (EEPROM), non-volatile ROM, and RAM.

In one implementation, a computer system for performing the method steps includes 1) one or more computer that is located remotely from a user and connected to the Internet and to each other and 2) a computer or computing device accessible to the user that can communicate with the remote computer(s) through a network. The remote computer(s) can be a fixed position computer, and the user's computer or computing device can be fixed such as a desktop computer or mobile/portable. The user's computer or device can be a desktop computer, laptop, tablet, gaming device, PDA, or smartphone that can access the graphic user interfaces depicted in FIGS. 1A-3A and FIGS. 4-8. The graphical user interfaces can be downloaded together as an application from cloud storage services providing retail application downloading to the user's computer or computing device, or can be hosted on a remote computer which acts as a web server and accessed through the internet as webpages through an Internet browser on the user's computer or computing device. The remote computer(s) can receive geographic area or other data related to a new housing project or property inputted by the user through the user interface (either provided as the application on the user's computer or device, or accessed through the web server) and can have a memory capable of housing storages of the inputted information on a subject project or subject property. The memory can house one or more Machine Learned Models as programming used to predict the base price of a new residential property. A repository of projects or properties and their features that can be used to generate a ranking of similar projects or make price predictions can be stored in relational databases (e.g., Oracle, SQL Server) stored in memory that communicate by way of a database server or servers with the user's computer or computing device(s) or other remote computer(s). The remote computer(s) can include a set of computer-executable instructions stored in memory which can be used to perform predictions by the Machine Learned Model. The remote computer(s) can then communicate to the user's computer or computing device the results of such predictions with respect to the predicted base price of the subject property as well as factors which explain the relative contributions of the inputted features to the predicted price. In some implementations, some steps of the methods are performed on the user's computer or computing device instead of remotely. In other implementations, all the steps are performed on the user's computer or computing device. The methods need not limited to one particular distribution of functions between those hosted on the user's computer or computer device and those hosted remotely; multiple configurations hosted on one or more computers are contemplated.

Additional embodiments include a computer, computing device, or system or combination thereof capable of carrying out the method and its implementations. The computer, computing device, system or combination thereof can include one or more processors capable of executing the computer-readable code, computer-readable instructions, computer-executable instructions, or “software”, one or more interface capable of providing input or output, one or more databases and a set of instructions (e.g., software) stored in a memory of the computer, computing device, or system or combination thereof for carrying out the method. The computer, computing device, or system or combination thereof can include one or more stand-alone computer, such as a desktop computer, a portable computer, such as a tablet, laptop, PDA, gaming device, or smartphone, or a set of computers or devices connected through a network including a client-server configuration and one or more database servers. The network can use any suitable network protocol, including IP, UDP, or ICMP, and may be any suitable wired or wireless network including any local area network, wide area network, Internet network, telecommunications network, Wi-Fi enabled network, or BLUETOOTH® enabled network. Other protocols include Hypertext Transfer Protocol (HTTP), extensible markup language (XML), extensible hypertext markup language (XHTML), or a Wireless Application Protocol (WAP) protocol. In this way, one or more steps of the methods can be distributed across the system or combination, or performed on only one computer or computing device, according to specific applications or designs.

Computers, computing devices, or systems thereof described herein can include a variety of components known in the art, including one or more processor, a volatile memory, a non-volatile memory, standard I/O interfaces such as a universal serial bus (USB) port, an HDMI or HDMI ARC port, an optical port, an ethernet port, and/or a serial port, a hard drive, a disk drive, a CD-ROM drive, a motherboard, a printed circuit board (PCB), circuitry for enabling a wireless connection or communication to another device, such as a BLUETOOTH© board, a Wi-Fi board, or a transmitter-receiver for mobile telecommunications, a data bus, an address bus, a control bus, and/or one or more user interface devices including a display, keyboard, keypad, trackpad, mouse, control panel, touch screen display, speaker, camera, and/or microphone. The computers, computing devices, or systems thereof can be equipped with an operating system implemented as software or firmware. As can be appreciated, the computers, computing devices, or systems may differ in their inclusion, exclusion, or configuration of components according to their individual applications or designs.

The present disclosure has described particular implementations having various features. In light of the disclosure provided above, it will be apparent to those skilled in the art that various modifications and variations can be made without departing from the scope or spirit of the disclosure. One skilled in the art will recognize that the disclosed features may be used singularly, in any combination, or omitted based on the requirements and specifications of a given application or design. When an implementation refers to “comprising” certain features, it is to be understood that the implementations can alternatively “consist of” or “consist essentially of” any one or more of the features. Other implementations will be apparent to those skilled in the art from consideration of the specification and practice of the disclosure.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the disclosure fall within the scope of the disclosure. Further, all of the references cited in this disclosure including patents, published applications, and non-patent literature are each individually incorporated by reference herein in their entireties and as such are intended to provide an efficient way of supplementing the enabling disclosure as well as provide background detailing the level of ordinary skill in the art.

1. A computer-implemented method, comprising:
creating a training set by inputting or receiving information on features of a plurality of residential properties, the features comprising square footage, lot area, number of beds, number of baths, number of floors, garage size, lot width, home owner association fee, and geographic location, and prices of the residential properties comprising a new construction project marketed price for a set of related properties constructed by a single builder, a property listing price, and a property closing price;
storing, on one or more database server(s), the information on the features and prices of the residential properties;
training, by one or more computer processor(s), a Machine Learning Algorithm chosen from Random Forest and Gradient Boost using the training set by providing the information on the features and prices of the residential properties to the Machine Learning Algorithm to determine the relationship between the features and the prices of the residential properties to create a Machine Learned Model;
inputting or receiving information, on one or more graphical user interface(s) displayed on a personal computer or smartphone by way of a set of computer-executable instructions of a user application, on the features of a new residential property into the Machine Learned Model;
sending the input received from the one or more graphical user interface(s) of the user application to one or more web server(s) by way of a network connection;
predicting, by one or more computer processor(s) of the one or more web server(s), a base price of the new residential property from the Machine Learned Model based on the features of the new residential property;
sending the base price prediction from the one or more web server(s) to the user application by way of the network connection; and
receiving or outputting the base price on the one or more graphical user interface(s) of the user application.

2-5. (canceled)

6. The method of claim 1, further comprising plotting the geographic locations of similar residential properties used to predict the base price of the new residential property on a map.

7. The method of claim 1, further comprising determining each contribution of the features of the new residential property on the base price prediction.

8. The method of claim 7, further comprising plotting the contribution of each feature as a SHAP Value ($).

9. The method of claim 7, further comprising plotting the contribution of each feature as a Features Force Plot.

10. The method of claim 1, further comprising determining the geographic location of the new residential property by way of a mapping application.

11. (canceled)

12. (canceled)

13. One or more non-transitory, computer-readable storage media having instructions for execution by the one or more processors, the instructions programmed to cause the one or more processors to:
create a training set by inputting or receiving information on features of a plurality of residential properties, the features comprising square footage, lot area, number of beds, number of baths, number of floors, garage size, lot width, home owner association fee, and geographic location, and prices of the residential properties comprising a new construction project marketed price for a set of related properties constructed by a single builder, a property listing price, and a property closing price;
store, on one or more database server(s), the information on the features and prices of the residential properties;
train, by one or more computer processor(s), a Machine Learning Algorithm chosen from Random Forest and Gradient Boost using the training set by providing the information on the features and prices of the residential properties to the Machine Learning Algorithm to determine the relationship between the features and the prices of the residential properties to create a Machine Learned Model;
input or receive information, on one or more graphical user interface(s) displayed on a personal computer or smartphone by way of a set of computer-executable instructions of a user application, on the features of a new residential property into the Machine Learned Model;
send the input received from the one or more graphical user interface(s) of the user application to one or more web server(s) by way of a network connection;
predict, by one or more computer processor(s) of the one or more web server(s), a base price of the new residential property from the Machine Learned Model based on the features of the new residential property;
send the base price prediction from the one or more web server(s) to the user application by way of the network connection; and
receive or output the base price on the one or more graphical user interface(s) of the user application.

14-16. (canceled)

17. A computer or computer system, comprising:
one or more processors designed to execute instructions; and
one or more non-transitory, computer-readable memories storing program instructions for execution by the one or more processors, the instructions programmed to cause the one or more processors to:
create a training set by inputting or receiving information on features of a plurality of residential properties, the features comprising square footage, lot area, number of beds, number of baths, number of floors, garage size, lot width, home owner association fee, and geographic location, and prices of the residential properties comprising a new construction project marketed for a set of related properties constructed by a single builder, a property listing price, and a property closing price;
store, on one or more database server(s), the information on the features and prices of the residential properties;
train, by one or more computer processor(s), a Machine Learning Algorithm chosen from Random Forest and Gradient Boost using the training set by providing the information on the features and prices of the residential properties to the Machine Learning Algorithm to determine the relationship between the features and the prices of the residential properties to create a Machine Learned Model;
input or receive information, on one or more graphical user interface(s) displayed on a personal computer or smartphone by way of a set of computer-executable instructions of a user application, on the features of a new residential property into the Machine Learned Model;
send the input received from the one or more graphical user interface(s) of the user application to one or more web server(s) by way of a network connection;
predict, by one or more computer processor(s) of the one or more web server(s), a base price of the new residential property from the Machine Learned Model based on the features of the new residential property;
send the base price prediction from the one or more web server(s) to the user application by way of the network connection; and
receive or output the base price on the one or more graphical user interface(s) of the user application.

18-20. (canceled)

21. A computer-implemented method, comprising:
inputting or receiving information, by way of a graphical user interface displayed on a personal computer or smartphone by way of a set of computer-executable instructions of a user application, features of a new residential property comprising square footage, lot area, number of beds, number of baths, number of floors, garage size, lot width, home owner association fee, and geographic location into a decision tree-based Machine Learned Model having been trained with a plurality of residential properties to identify an approximation function defining the relationship between the features of the residential properties and prices of the residential properties comprising a new construction project marketed price for a set of related properties constructed by a single builder, a property listing price, and a property closing price, such features and prices of the plurality of residential properties stored on one or more database server(s);
sending the input received from the one or more graphical user interface(s) of the user application to one or more web server(s) by way of a network connection;
predicting, by way of one or more computer processor(s) of the one or more web server(s), a base price of the new residential property from the decision tree-based Machine Learned Model based on the features of the new residential property;
sending the base price prediction from the one or more web server(s) to the user application by way of the network connection; and
receiving or outputting the base price on the one or more graphical user interface(s) by way of the user application.

22. The computer-implemented method of claim 21, wherein the plurality of residential properties represents a plurality of housing projects constructed by multiple builders.

23. The computer-implemented method of claim 22, wherein the plurality of housing projects comprises properties chosen from houses, apartments, townhouses, condominiums, and villas.

24. (canceled)
